(19) United States
(12) Patent Application Publication
(10) Pub. No.: US 2019/0391114 A1
(43) Pub. Date: Dec. 26, 2019

(54) METHOD AND APPARATUS

(71) Applicant: Smiths Detection-Watford Limited, Hemel Hempstead (GB)

(72) Inventors: Paul Douglas ARNOLD, Hemel Hempstead (GB); Immacolata PROCINO, Hemel Hempstead (GB)

(21) Appl. No.: 16/482,017

(22) PCT Filed: Jan. 31, 2018
(86) PCT No.: PCT/GB2018/050278

§ 371 Date: Jul. 30, 2019

(30) Foreign Application Priority Data
Jan. 31, 2017 (GB) 1701604.9

(51) Int. Cl. G01N 27/62

(52) U.S. Cl. CPC G01N 27/622

(57) ABSTRACT

A method of operating an IMS cell, the method including obtaining first ion mobility spectrometry (IMS) data indicating the time of flight of ions through a drift gas of an IMS drift chamber, identifying, in the first IMS data, a reference feature associated with a selected group of ions; providing a dose of water vapour into the IMS cell to shift the reference feature to a selected time interval; and controlling dosing of water vapour into the drift gas based on second IMS data obtained using the IMS drift chamber to keep the reference feature within the selected time interval.

### CROSS REFERENCE TO RELATED APPLICATIONS

This patent application is a National Stage Entry of PCT/GB2018/050278 filed on Jan. 31, 2018, which claims priority to GB Application No. 1701604.9 filed on Jan. 31, 2017, the disclosures of which are hereby incorporated by reference herein in their entirety as part of the present application.

### FIELD OF INVENTION

The present disclosure relates to ion mobility spectrometry, and more particularly to methods and apparatus for using the effects of moisture in ion mobility spectrometry to provide improved detection and/or selection of ions based on their mobility.

### TECHNICAL BACKGROUND

Ion mobility Spectrometry (IMS) may be used to detect substances of interest such as explosives, chemical weapons and narcotics. They may be used in a variety of environments and deployed either in static circumstances such as in an airport or other facility, or they may be carried as handheld detectors or fitted to vehicles.

IMS cells typically include a drift chamber in which the passage of ions through a gas under the influence of an electric field is used to separate the ions according to their mobility. This separation effect may be used to detect ions (e.g. to identify the presence of ions having particular mobility) or to select ions (e.g. to select ions from a sample based on their mobility, and then to provide those selected ions to another detector such as a mass spectrometer).

The presence of moisture in IMS devices is a significant source of contamination and error, and variations in ambient humidity may cause loss of accuracy in ion mobility spectrometry measurements. Designers of ion mobility spectrometers go to considerable lengths to exclude moisture from IMS cells. For example, air in an IMS system may be constantly recirculated through a so-called molecular sieve to remove water vapour. Such sieves need to be replaced frequently to ensure the performance and reliability of the IMS device is maintained.

### SUMMARY

Aspects and examples of the disclosure are set out in the claims. These and other embodiments of the disclosure aim to improve accuracy and reliability in ion mobility based methods and apparatus for separating and/or detecting ions.

Such embodiments may operate by controlling a dose of water vapour which is added to the drift gas of an IMS cell. The dose may be chosen based on previous ion mobility measurements performed by the IMS cell.

IMS apparatus according to the present disclosure may employ time of flight ion mobility methods in which a voltage of known spatial profile (e.g. a linear voltage profile of constant gradient) is used to move ions against a flow of drift gas. The voltage may move ions from an ion gate towards an ion collector such as a Faraday cup. The timing of arrival of ions at the collector relative to the timing of the opening of the ion gate may then be used to draw inferences about the mobility of the ions.

Electrical current associated with the arrival of ions at the collector may be integrated to provide a plasmagram. The plasmagram generally indicates the number of ions arriving at the collector as a function of time. The timing of a feature such as a known peak in the plasmagram may thus indicate the time of arrival of a corresponding known group of ions at the collector.

Embodiments of the present disclosure may control the dosing of water vapour into an IMS cell based on measurements of such known features. For example, a controlled dose of water vapour may be provided into a drift gas of an IMS cell to shift such a feature into a selected time interval on the plasmagram (e.g. so that the group of ions associated with that peak arrive at the ion collector within a selected time interval after the opening of the ion gate).

During subsequent operation of the IMS cell, that same dose of water may be added. If the feature moves in the plasmagram (e.g. is advanced or delayed in timing) the dose of water vapour may be increased or decreased to keep the feature within the selected time interval.

### BRIEF DESCRIPTION OF DRAWINGS

Embodiments of the present disclosure will now be described, by way of example only, with reference to the accompanying drawing in which:

FIG. 1 illustrates an ion mobility spectrometry apparatus;

FIG. 2 is a flow chart illustrating a method of operating an apparatus such as that shown in FIG. 1;

FIG. 3 is a flow chart illustrating another method of operating an apparatus such as that shown in FIG. 1;

FIG. 4 illustrates an apparatus which can be built into an ion mobility spectrometry apparatus; and

FIG. 5 illustrates an ion mobility spectrometry apparatus.

In the drawings like reference numerals are used to indicate like elements.

### DETAILED DESCRIPTION

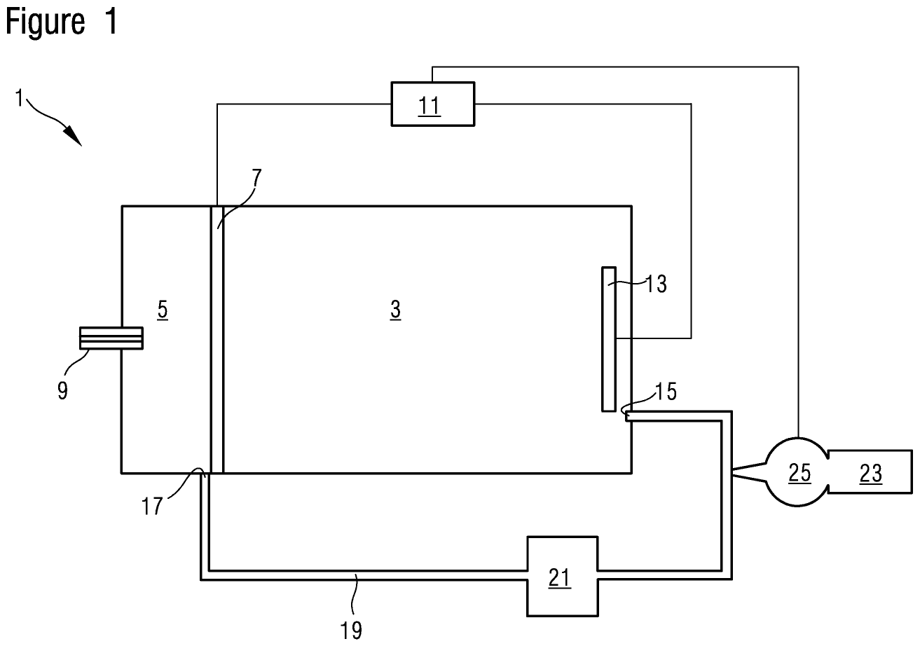

FIG. 1 shows ion mobility spectrometry (IMS) apparatus 1 including a reservoir 23 of water vapour, a drift gas recirculation channel 19 and a vapour dose provider 25 which is connected to the reservoir 23 and to the drift gas recirculation channel 19. The drift gas recirculation channel 19 runs from a drift gas outlet 17 of a drift chamber 3 of the IMS apparatus 1 to a drift gas inlet 15 of that drift chamber.

The drift gas inlet 15 allows drift gas to be introduced to the drift chamber, and generally this drift gas inlet 15 is arranged in the end of the drift chamber 3 which is behind a collector electrode 13 used to detect ions. The drift gas outlet 17 is generally at the other end of the drift chamber 3 from the drift gas inlet. For example, the drift gas outlet 17 may be near the ion gate 7 which is used to control the passage of ions into the drift chamber. For example, the ion gate 7 may lie between the drift gas outlet 17 and the drift chamber.

The drift gas outlet 17 is linked to the drift gas inlet 15 by the drift gas recirculation channel 19. This enables a flow of drift gas to be passed from the drift gas inlet, along the drift chamber 3 to the drift gas outlet 17 before being passed back through the recirculation channel 19 to flow through the drift chamber 3 again. A molecular sieve 21 may be provided in the recirculation channel 19 between the drift gas outlet 17 of the chamber and the drift gas inlet 15 into the chamber at the other end of the channel 19. The sieve 21 typically includes a porous material in which the pores may be of uniform size. The porous material of the molecular sieve 21 may include a desiccant such as activated charcoal or silica gel.

The reservoir 23 may include a chamber for holding a source of water vapour such as a capsule having a water permeable wall. This capsule may be disposed in a chamber so that water that permeates through the wall is released into the chamber as water vapour. For example, the water permeable wall of the capsule may include PTFE. The capsule may be at least partially filled with liquid water.

The vapour dose provider 25 is arranged to obtain water vapour from the reservoir 23, and to provide a selected quantity of that water vapour into the gas recirculation channel 19. Generally the vapour dose provider 25 is arranged to provide this dose of water vapour into the recirculating flow of drift gas between its exit from the sieve and its entry to the drift chamber 3 (for example behind a collector electrode 13 at one end of the drift chamber, e.g. at the drift gas inlet 15 to the drift chamber).

The vapour dose provider 25 may include an electromechanical actuator, such as a piezo electric pump. The vapour dose provider may include a dosing pump, which is controllable to move a dose (a discrete known quantity of water vapour) from the reservoir 23 into the gas recirculation channel 19. Accordingly, it will be appreciated that the quantity of water vapour that is added by the vapour dose provider 25 may be chosen by selecting the rate at which these doses of water vapour are introduced to the drift gas recirculation channel 19 relative to the volume flow rate of drift gas through that channel 19.

The IMS apparatus 1 may include an ion gate 7 including an arrangement of electrodes which can be opened to allow ions to pass into the drift chamber 3 from a reaction region, or closed to inhibit ions from passing into the drift chamber 3 from the reaction region. Such arrangements of electrodes may include arrays of elongate conductors such as wires which may be arranged across the IMS cell to separate the drift chamber 3 from the reaction region. These elongate conductors may be interdigitated so that application of a potential difference between the conductors can create a barrier voltage to inhibit (for example to prevent) the passage of ions through the gate. Examples of ion gates include a Bradbury-Nielsen shutter, and a Tyndall-Powell gate. Other kinds of ion gate 7 may be used.

The IMS apparatus 1 may include an inlet 9, for example an aperture (e.g. a pinhole) or membrane inlet for introducing an analyte such as a sample vapour. It may also include an ioniser such as a corona discharge electrode or other source of ions. The ioniser may be operated to ionise air and/or a calibrant and/or dopant, thereby to generate so called reactant ions (also known as primary ions). These reactant ions can then be combined with an analyte in a reaction region 5 of the IMS apparatus 1 to ionise that analyte. In operation of an IMS apparatus, the detection signal generated by the detector may be expected to include a signal associated with ion species such as these reactant, calibrant, or dopant ions which are known to be present. Examples of reactant ions include (H₂0)ₙH⁺ and (H₂O)ₙO⁻. The known or expected signals associated with such ions can be identified in the ion detection signal obtained from the ion collector. For example, in the absence of analyte, the largest amplitude signal may be associated with the reactant ions.

The IMS apparatus 1 illustrated in FIG. 1 may also include a controller 11, arranged to receive ion detection signals from the ion collector indicating the timing, relative to the opening of the ion gate, of the arrival of ions at the ion collector. The controller 11 may be configured to identify, in these signals, a detection signal associated with the arrival of a known (or expected) group of ions at the ion collector. Examples of known or expected ions include calibrants or dopants and reactant ions as explained above.

The controller 11 may be configured to identify the timing of the highest amplitude peak in an ion detection signal, and to use the timing of this peak as a measure of the reactant ion peak. This detection signal may be obtained in the absence of an analyte, for example during a cycle of operation of the IMS cell in which no sample vapour is present so the majority of ions will just be the reactant ions.

The controller may also be configured to determine whether the highest amplitude peak exceeds a defined minimum amplitude threshold, and/or whether it arises within a selected time interval. In the event that the largest peak meets these two criteria, the controller may identify it as the reactant ion peak.

In operation, the ioniser is operated to provide reactant ions, which may be combined with an analyte in the reaction region. The ion gate 7 is opened to allow the ions to pass from the reaction region 5 into the drift chamber 3 of the IMS cell. A signal is generated at the ion collector in response to the arrival of ions from the ion gate 7 at the ion collector. This provides IMS data indicating the time of flight of ions through drift gas along the drift chamber. The controller 11 processes this data to identify one or more reference features, such as the reactant ion peak. As explained above, this may be identified by choosing the highest amplitude peak in the absence of an analyte. Alternatively, in a normal range of pressures and temperatures, the largest amplitude peak in a known time interval may be identified as the reference feature. For example, the reactant ion peak may be known to occur within a selected (e.g. predetermined or reconfigurable) time interval after gate opening, and the controller 11 may be configured to identify the largest amplitude peak in this interval as the reference feature.

This first IMS data indicates the time of flight of ions through the drift gas, and the reference feature provides an indication of the time of flight of a selected group of those ions (such as the reactant ions, or another known group of ions that can be used as a timing reference).

The controller 11 then operates the vapour dose provider to add a selected dose of water vapour into the drift gas of the IMS cell. This addition of moisture into the drift gas will tend to increase the time of flight of ions through that drift gas, and as a result the reference feature will be delayed. Accordingly, the controller 11 can add a dose of water vapour into the IMS cell to delay the arrival of the selected group of ions (e.g. the reactant ions) at the collector. This can shift the reference feature so that it occurs during a particular selected time interval.

In further operating cycles of the IMS cell, the controller 11 operates the vapour dose provider 25 to increase or decrease the dose of water vapour so that the reference feature of the collection signal is kept within that particular selected time interval. This is significant because it can enable the effect of ambient moisture to be controlled—if an increase in ambient moisture causes the reference feature to be delayed, the level of moisture added to the drift gas can be reduced to return the reference feature to the selected time interval. Conversely, if a reduction in ambient moisture causes the reference feature to precede the interval, the controller 11 can increase the dose of water vapour to delay the reference feature.

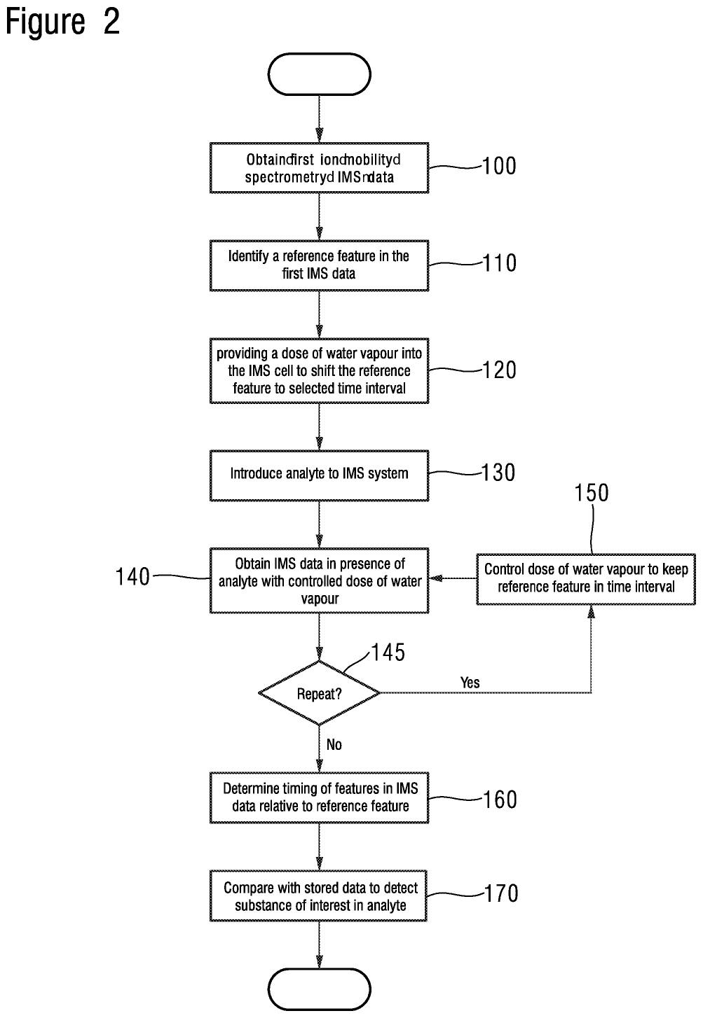

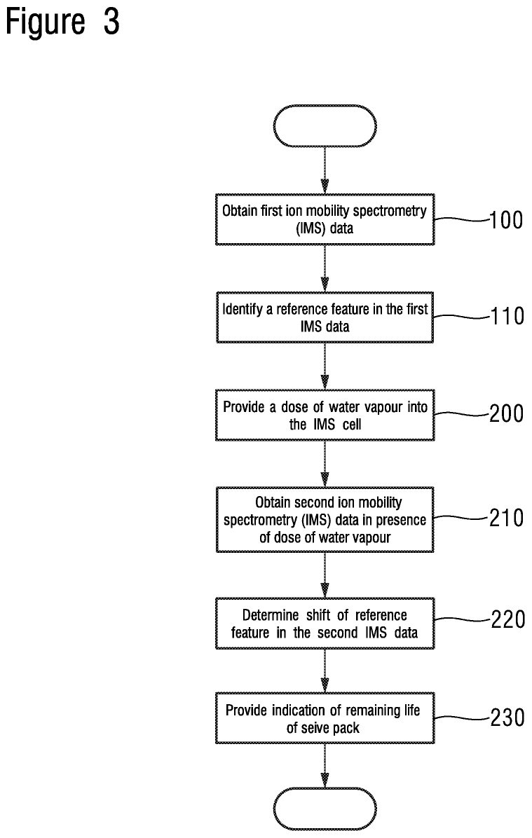

The controller 11 may be configured to use the timing of ion detection signals relative to this reference feature in order to detect the presence of a substance of interest in a sample, or to detect the remaining life of a molecular sieve used to remove water vapour from the drift gas system as explained below. One example of the former is described with reference to FIG. 2. The latter is described with reference to FIG. 3.

It will be appreciated in the context of the present disclosure that the apparatus 1 illustrated in FIG. 1 may be arranged in a variety of different ways. For example one or more molecular sieves may be disposed in the gas recirculation channel 19 so that the flow of drift gas through the channel 19 also passes through those molecular sieve(s) along its route. The sieve(s) may be provided in removable/replaceable cartridges known as “sieve packs” which can be replaced during maintenance to extend the useful life of an IMS device. Generally, the output from the vapour dose provider 25 is connected to the recirculation channel 19 so that it can provide the vapour into the flow of drift gas after it has passed through the sieve(s). For example, the output of the dose provider 25 may be connected into a tube or conduit of the channel 19 which runs from the sieve pack to an outlet from the channel 19 into the IMS drift chamber 3 (e.g. the drift gas inlet 15 of the IMS cell). However, instead of being provided into this tube or conduit, the output from the dose provider 25 may be provided at that outlet, e.g. at the point the recirculation channel 19 joins the drift chamber. In some embodiments, the vapour dose provider 25 may be arranged instead to provide water vapour into the reaction region 5 of the IMS cell.

It will also be appreciated that features such as the collector electrode 13 need not be provided by a collector electrode in the conventional sense—for example, a passage may be provided to allow ions from the IMS cell to reach another spectrometer, such as a mass spectrometer. The passage itself may be configured to sense passing charge (e.g. by capacitive sensing) to enable the methods described herein to be applied. In addition, or as an alternative a second ion gate could be used to select groups of ions which are to be allowed to leave the detector through such a passage so that the IMS cell can be used to pre-select ions which are to be passed on for analysis in a mass spectrometer.

As illustrated in FIG. 2, during an initial phase of operation—a first set of IMS data is obtained 100. To this, the ioniser may be operated to provide reactant ions, and the ion gate opened to allow the reactant ions to pass from the reaction region 5 into the drift chamber 3 of the IMS cell. A signal can then be generated at the ion collector in response to the arrival of the ions from the ion gate at the ion collector. This provides first IMS data indicating the time of flight of ions through drift gas along the drift chamber.

The controller 11 processes this data to identify 110 a reference feature in the IMS data, such as the reactant ion peak.

The controller 11 then operates 120 the vapour dose provider to add a selected dose of water vapour into the drift gas of the IMS cell to delay the reference feature. In the presence of this dose of water vapour, the controller 11 operates the IMS cell to identify the new (delayed) timing of the reference feature by collecting further IMS data.

In a detection phase of operation, an analyte is introduced 130 into a reaction region 5 of the IMS cell in the form of a vapour, and an ioniser is operated to provide reactant ions. The reactant ions are combined with the analyte vapour to ionise it. The result of this process is a mixture of reactant ions and product ions (ionised analyte) in the reaction region. The controller 11 then opens the ion gate to allow the ions from the reaction region 5 to travel along the drift chamber 3 towards the ion collector. The controller 11 also operates the vapour dose provider so that the drift gas in the drift chamber 3 during the drift time of the ions along the drift chamber carries the vapour water dose that has been determined during previous operation of the IMS cell (to shift the reference feature to a particular selected time interval). The controller 11 then obtains 140 a detection signal from the collector which includes signals associated with the substances in the analyte vapour, and the reference feature (such as the reactant ion peak associated with the reactant ions). The controller 11 may then identify the reference feature in this data, and the controller 11 may determine 145 whether to repeat the measurement. If the measurement is to be repeated, the dose of water vapour is controlled 150 to keep the reference feature in the selected time interval.

In the detection signal from the collector the controller 11 may identify a peak, or series of peaks associated with the substances in the analyte vapour, and the reference feature.

The controller 11 then determines 160 the timings of the peaks in the IMS data obtained in the presence of the analyte relative to the timing of this reference feature, and compares 170 this timing data with stored data to detect the presence of a substance of interest in the analyte. For example, the stored data may include comparator data associated with particular substances which may be defined relative to the timing of the reference feature such as the reactant ion peak.

In addition, or as an alternative to the reactant ion peak, other reference features in the detection signal may also be used. For example a dopant may be used. In these embodiments, the dopant can be introduced into the reaction region by a dopant vapour dispensing system such as that described and claimed in WO2014/045067. This peak may be identified in any one of a number of ways. For example, the highest amplitude peak in a time window associated with the dopant may be used. For example, a constant flow of dopant may be used so the amount of dopant accumulates in the system over a number of cycles. The controller may then identify the dopant peak as the peak which increases in amplitude through those cycles as the dopant is introduced into the system. The dose need not simply accumulate—in some embodiments the controller may operate such a vapour dispensing system to add a dose which varies according to a selected pattern (e.g. increasing, decreasing, cyclic, or otherwise time varying) over a series of cycles of operation of the IMS. In these embodiments the controller is configured to identify the peak in the detection signal which varies in amplitude according to the selected pattern of the doses of dopant.

If dopants are used in this way, then to perform IMS measurements of an analyte with the addition of water vapour as described above, the dopant may be added to the reaction region 5 with the analyte vapour. This then provides a reference feature, and the stored comparator data used for comparisons to detect substances of interest may define the timing of peaks associated with these substances of interest by reference to the timing of the peak (or peaks) associated with the dopant.

Calibrants may also be used in this way. Examples of such calibrants include dimethyl methylphosphonate (DMMP), 2,4-lutidine, dipropylene glycol mono methyl ether, (DPM) methyl salicylate (MS) and other calibrants. In addition to being used directly to provide the reference feature as described above, the reactant ion peak (RIP) can also be identified using such calibrants. For example, dimers seen in IMS spectra of certain materials are particularly unaffected by the effects of moisture within an IMS system and therefore their position can be used as a reference to verify the expected position of the RIP. This can be enhanced further by using the monomer position of the same calibrant which often exhibits predictable characteristics with respect to levels of water vapour within an IMS, thus further reducing the width of the window required to target the position, or drift time of the RIP.

It will be appreciated by the skilled addressee in the context of the present disclosure that a series of IMS experiments may be conducted on any given sample. In this eventuality, the controller 11 may monitor the reference feature in the IMS data and adapt the dose of water vapour added from the reservoir 23 to keep the reference feature in the particular selected time interval. This may improve detector accuracy (for example by reducing the occurrence of false positives without reducing effective sensitivity) by allowing the “detection window” used to identify substances of interest to be narrowed.

In addition to improving detector accuracy, embodiments of the disclosure may be used to determine the maintenance condition of a sieve pack of an IMS device.

FIG. 3 illustrates one method of doing this.

As illustrated in FIG. 3, during an initial phase of operation 100 the ioniser is operated to provide reactant ions, and the ion gate is opened to allow the reactant ions to pass from the reaction region 5 into the drift chamber 3 of the IMS cell. A signal is generated at the ion collector in response to the arrival of the ions from the ion gate at the ion collector. This provides IMS data indicating the time of flight of ions through drift gas along the drift chamber. The controller 11 processes this data to identify 110 a reference feature in the IMS data, such as the reactant ion peak.

The controller 11 then operates the vapour dose provider to add 200 a selected dose of water vapour into the drift gas of the IMS cell to delay the reference feature.

During a testing phase of operation (with or without the addition of an analyte), the IMS device is operated 210 again with this dose of water vapour in the drift gas. This provides a second set of IMS data. The controller 11 then identifies the timing of the reference feature in this second IMS data, and determines 220 whether there has been any shift in its timing as compared to data collected without that dose of water vapour.

In the event that the reference feature is delayed less than expected (e.g. less than a minimum threshold delay), the controller 11 may provide 230 a signal to the operator such as an audible or visible output, indicating that the sieve pack should be replaced. This signal can indicate a maintenance status for the IMS cell. In some embodiments the IMS cell may have a communication interface adapted to transmit the alert to a remote device, for example over a wireless network or over a wired link. The transmission may be triggered in response to docking with a battery charger or other device.

It will be appreciated in the context of the disclosure of FIG. 3 that the available movement of the RIP may depend on the initial dryness of the IMS system. Embodiments can add moisture to that already in the system, which will move the RIP to a “wetter” position, i.e. to the right. Removing the additional moisture will return the RIP to its initial position, i.e. the position which is determined by the initial wetness of the system, as per the condition of the sieve at that time. Thus a “wet” sieve pack near or on its useful life may result in a system where the movement of the RIP will not be useful or even possible—the RIP in this condition will already be in its “wettest” position in the spectrum. In some embodiments the controller 11 can be configured to determine the condition, or remaining life of the sieve pack by operating the vapour dose provider 25 to add moisture to the drift gas, and determining whether a reference feature in the IMS system is delayed by that addition. If, say, it is not possible to delay the reference feature (move the RIP to the right) by adding moisture to the drift gas then it could be concluded that the sieve has reached the end of its useable life. In some embodiments a series of increasing doses of water may be added to the IMS cell, and so that the controller 11 can determine the maximum shift that can be applied to the reference feature. The controller 11 may store comparator data providing a relationship between the maximum available shift of the reference feature and the remaining life of the sieve pack. Accordingly, instead of or in addition to, merely providing an alert signal, the controller 11 may provide output data indicating the remaining life of the sieve pack.

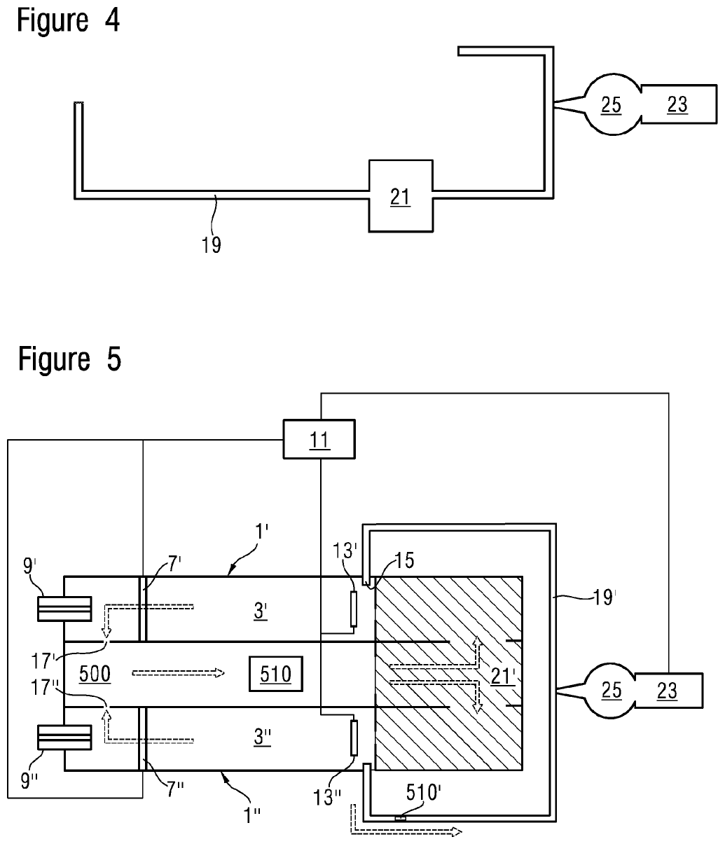

It will also be appreciated by the skilled addressee in the context if the present disclosure that it may be possible to retrofit the apparatus described above into existing IMS systems by adapting their drift gas system and reconfiguring the controller 11 which operates those systems. For example, an IMS system may be adapted by adding a reservoir 23 of water vapour to it, and including a vapour dose provider 25 which is connected between the reservoir 23 and a drift gas recirculation channel 19 of the IMS system. One example of such an apparatus is illustrated in FIG. 4.

As shown in FIG. 4, an apparatus for installation into an IMS system may include a gas recirculation channel 19, a reservoir 23, and a vapour dose provider 25. The gas recirculation channel 19 illustrated in FIG. 2 is adapted for coupling to ion mobility spectrometry (IMS) drift chamber 3 to recirculate a flow of drift gas from a drift gas outlet 17 of the IMS drift chamber 3 to a drift gas inlet 15 of the IMS drift chamber. The recirculation channel may include a sieve pack as described elsewhere herein.

The reservoir 23 for providing a source of water vapour may include a chamber housing a permeable capsule as described elsewhere herein.

The apparatus illustrated in FIG. 4 also includes a vapour dose provider 25, such as a piezo pump. This can have an inlet connected to the reservoir 23 for obtaining water vapour, and an outlet connected to the gas recirculation channel 19. This can enable a controllable dose of water vapour to be provided into the drift gas recirculation channel 19.

FIG. 5 illustrates another possible implementation. As illustrated in FIG. 5, some examples of an ion mobility spectrometer may include two IMS cells. A first cell 1′ may have a drift chamber 3′ adapted for detecting positive ions, whilst the second cell 1″ has a drift chamber 3″ configured for detecting negative ions. The apparatus illustrated in FIG. 5 also includes a combined sieve pack 21′, arranged to sieve the drift gas from both the first IMS cell 1′ and the second IMS cell 1″. It also includes a gas recirculation channel 19′, a reservoir 23 for water vapour and a vapour dose provider 25 arranged to provide a dose of water vapour from the reservoir into the recirculation channel 19′. An air mover 510′, such as a fan or pump, may be arranged (e.g. in the recirculation channel 19′) for causing flow to pass from the inlet of the recirculation channel 19′, past the vapour dose provider to the outlet 15 of the recirculation channel 19′.

Each of the two IMS cells 1′, 1″, includes a collector 13′, 13″, and an ion gate 7′, 7″, which separates a reaction region 3′, 3″ of the cell from its drift chamber.

Each cell 1′, 1″ also includes an inlet 9′, 9″. The inlets 9′ may each include either an aperture (e.g. a pinhole) or membrane inlet, and are each arranged to allow a sample vapour to be introduced into the reaction region of each respective cell.

In the drift chamber 3′ of the first (positive mode) cell 1′, a voltage profile is applied to move positive ions toward the collector. In the drift chamber 3″ of the second (negative mode) cell 1″, a voltage profile is applied to move negative ions toward the collector.

In each cell, a drift gas inlet 15 is provided into the drift chamber near (for example behind) the collector electrode. This allows drift gas to flow along each drift chamber to a drift gas outlet 17′, 17″ at the other end of the drift chamber (e.g. the end near the gate). The drift gas outlet of the first cell and drift gas outlet of the second cell both allow drift gas to flow out of the cells and into a vent chamber 500.

The vent chamber 500 includes an air mover 510, such as a pump or fan, which draws air out of the drift gas outlet of each of the two IMS cells, and through the vent chamber and into a combined sieve pack.

The combined sieve pack 21 includes molecular sieve material such as that described above with reference to FIG. 1. The combined sieve pack provides a flow path for drift gas to flow out of the vent chamber, through the sieve material, and into a first drift gas inlet of the first IMS cell and into a second drift gas inlet of the second IMS cell. Accordingly, drift gas which has passed through the drift chambers of the two IMS cells is passed through the combined sieve pack (where it is cleaned and dried) and then passed back into each of the two drift chambers.

In the embodiment illustrated in FIG. 5, the drift gas circulation channel is arranged to draw clean dried air out of the second drift chamber behind the collector electrode (e.g. at the drift gas outlet from the combined sieve pack). The vapour dose provider 25 can then provide a dose of water vapour into this flow of drift gas before it is introduced back into the first drift chamber behind the collector electrode of the first IMS cell (e.g. at the drift gas outlet from the combined sieve pack). In this arrangement, dry air is taken from the second drift chamber, moistened and introduced to the first drift chamber. This may allow existing systems, such as those which have two cells, a vent chamber and a combined sieve pack, to be adapted to employ methods of the present disclosure. This may mean that the methods are employed only in the positive mode cell or only in the negative mode cell. In other configurations doses of moisture may be added to both cells. For example, an air mover (such as a pump or fan) may be provided in the recirculation channel to drive the flow of drift gas through the channel. This may be reversible so that when the first IMS cell is in use, dry drift gas is taken from the second IMS cell and moistened (according to the methods described elsewhere herein) before being introduced to the first. Conversely, when the second IMS cell is in use drift gas is taken from the first IMS cell and moistened before being introduced to the second.

It will be appreciated in the context of the present disclosure that the apparatus and methods described herein may be varied in a number of ways and may be more widely applied. For example, the methods of controlling the dosing of water vapour may be applied in ion mobility based devices other than time of flight systems. For example they may be used in differential ion mobility spectrometers, field asymmetric ion mobility spectrometers, mobility based ion selection stages for mass spectrometer inlets, and other devices.

In some embodiments the reservoir 23 may include a chamber which is connected to the vapour dose provider 25, and a water permeable barrier disposed between the chamber and an inlet for ambient air. The barrier in such arrangements includes a water permeable material such as silicon which is arranged to provide a pneumatic seal between the chamber and the inlet for ambient air. This can permit water vapour to permeate into the chamber whilst excluding particulates, dirt, and other contaminants.

Embodiments described herein may be able to calibrate an IMS instrument against variables, such as contamination with moisture, which affect its performance. Indeed, although the present disclosure has focused on the use of water vapour, other “contaminants” could be stored in the reservoir and dosed into the system in the manner described herein. These and other embodiments (including water vapour embodiments) may enable an IMS cell to be calibrated so that the position of so called product peaks, on the IMS spectrum can be predicted with improved accuracy in the presence of varying background levels of such contaminants. Thus in a detector used to identify explosives, for example, the detection windows set up to target these product peaks within detection algorithms can be narrowed. This may improve the detection performance of the instrument by aiding the rejection of peaks from materials that cause false positive responses, i.e. there is less chance of alarming to a peak which is not of interest if it lies outside of the detection window. Thus, the narrower the detection window the less susceptible the system is to false alarms. Embodiments described herein exploit the susceptibility of the IMS system to the effects of internal moisture, or water vapour. Controlling the amount of water vapour present in the IMS system may enable the RIP to be effectively moved and then held in a desired position in the IMS spectrum; then by the process of feedback kept in that position.

The vapour dose provider 25 may include a piezoelectric pump used to introduce moist air from the reservoir into the drift flow. To vary the dose provided by such a pump the voltage applied to the pump can be controlled. This may cause the RIP position to change due to the increased moisture level in the IMS drift cell. The source of water could be an enclosed diffusion or permeation source, or a permeation method which utilizes water vapour present in the atmosphere. Whatever source of water vapour is used, embodiments described herein may provide a closed loop control system which can add or remove moisture in the IMS drift gas to maintain the RIP at a constant drift time (or within a selected range of times).

In an embodiment, the controller of the IMS systems described herein may be configured so that, when identifying a reactant ion peak, it repeats cycles of operation of the IMS with the sample inlet closed. Such IMS systems may include a heater for heating regions of the IMS such as the drift chamber and the reaction region. This may remove or reduce contamination to enable a “normal” reactant ion peak to be detected. If heating is used, the controller may be configured to allow the IMS system to cool back to its normal operating temperature before detecting the reactant ion peak.

It will be appreciated in the context of the present disclosure that that the moisture levels inside an IMS device may be affected by:

1: Ambient moisture levels, due to diffusion through the inlet

2: Ambient moisture levels, due to the ingestion of sample through the inlet, a more immediate effect than 1. Therefore sampling rate may have a significant contribution to moisture levels.

3: Changing a sieve pack

It will also be appreciated that IMS systems when turned on from cold may normally be “wetter” than they will be after a period of running. This is due to diffusion through inlets left open, or through elastomer seals, e.g. silicone. Embodiments of the present disclosure could be used to reduce these effects by preventing the natural drying out process proceeding by holding the internal moisture at a wetter level.

Ultraviolet light may be used to ionise a sample directly. More usually, sample is ionised indirectly by first generating ions from air within the detector using a corona discharge or source of ionising radiation, such as β-particles, and then mixing these ions with the sample to allow these ions to undergo ion-molecule reactions with the sample molecules. In this situation the initial ions generated are called reactant ions, and the ions produced from the sample molecules are called product ions. It may also be useful to add a vapour, called a dopant, to the detector, such that these become ionised by the initial air ions, and then these new reactant ions ionise the sample via ion-molecule reactions. In this way, the chemistry of the ionisation of the sample may be controlled to preferentially ionise the compounds to be detected and to not ionise some potential interferent compounds in the sample.

The controllers of the embodiments described herein may be implemented using controllers and/or processors which may be provided by fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

Embodiments of the disclosure provide computer program products, and computer readable media, such as tangible non-transitory media, storing instructions to program a processor to perform any one or more of the methods described herein.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit. It is suggested that any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

Some embodiments of the disclosure may be used in deadloss systems—that is to say the drift gas need not be recirculated. Instead air is drawn or pumped through an IMS from, say, the atmosphere, and exhausted back into the atmosphere. The incoming air being cleaned and dried by passing through molecular sieve before a dose of water vapour is added as described above. Accordingly, such embodiments of the disclosure provide an ion mobility spectrometry (IMS) apparatus including:

a drift chamber;

a gas supply channel for coupling to the drift chamber to provide a flow of drift gas from a drift gas outlet of the drift chamber to a drift gas inlet of the drift chamber;

a reservoir for providing a source of water vapour; and

a vapour dose provider coupled to the reservoir and to the gas supply channel for providing a controllable dose of water vapour into the flow of drift gas to adjust water vapour content of drift gas in the drift chamber. These embodiments of the disclosure may be used with any one or more of the embodiments described herein.

Other variations and modifications of the apparatus will be apparent to persons of skill in the art in the context of the present disclosure.

1. A method of operating an IMS cell, the method comprising:
obtaining first ion mobility spectrometry (IMS) data indicating the time of flight of ions through a drift gas of an IMS drift chamber;
identifying, in the first IMS data, a reference feature associated with a selected group of ions;
providing a dose of water vapour into the IMS cell to shift the reference feature to a selected time interval; and
controlling dosing of water vapour into the drift gas based on second IMS data obtained using the IMS drift chamber to keep the reference feature within the selected time interval.

2. The method of claim 1 wherein controlling comprises increasing the dose if the second IMS data indicates that the reference feature precedes the selected time interval

3. The method of claim 1 wherein controlling comprises decreasing the dose if the second IMS data indicates that the selected time interval precedes the reference feature.

4. The method of claim 1 wherein the dose of water vapour is provided into the drift gas.

5. The method of claim 4 wherein the dose of water vapour is provided into one of:
(a) a drift gas recirculation channel coupled to the IMS drift chamber; and
(b) at an outlet from the drift gas recirculation channel into the IMS drift chamber.

6. (canceled)

7. (canceled)

8. The method of claim 1 wherein the dose of water vapour is provided into a reaction region of the IMS cell.

9. The method of claim 1 comprising detecting a substance of interest in a sample based on a timing, relative to the selected time interval, of a detection feature in IMS data obtained in the presence of the dose of water vapour.

10. An ion mobility spectrometry (IMS) apparatus comprising the apparatus of claim 11 and a draft chamber.

11. An apparatus comprising:
a gas supply channel for coupling to ion mobility spectrometry (IMS) drift chamber to provide a flow of drift gas from a drift gas inlet of the IMS drift chamber;
a reservoir for providing a source of water vapour; and
a vapour dose provider coupled to the reservoir and to the gas supply channel for providing a controllable dose of water vapour into the flow of drift gas to adjust water vapour content of drift gas in the drift chamber.

12. The apparatus of claim 10 wherein the gas supply channel comprises a gas recirculation channel arranged to recirculate the flow of drift gas from a drift gas outlet of the drift chamber to the drift gas inlet.

13. The apparatus of claim 12 comprising a molecular sieve disposed in the gas recirculation channel so that the flow of drift gas passes through the molecular sieve, wherein the vapour dose provider is arranged to provide the controllable dose into the drift gas recirculation channel between the molecular sieve and an outlet from the channel into the IMS drift chamber.

14. (canceled)

15. The apparatus of claim 12 comprising a controller configured to control the dose of water vapour based on a reference feature of IMS data collected using the IMS drift chamber, wherein the reference feature is associated with one of: reactant ions, a calibrant, and a dopant.

16. (canceled)

17. The apparatus of claim 15 wherein the controller is configured to increase the dose of water vapour if the IMS data indicates that the reference feature precedes a selected time interval.

18. The apparatus of claim 15 wherein the controller is configured to decrease the dose if the IMS data indicates that the reference feature occurs later than a selected time interval.

19. The apparatus of claim 17, wherein the controller is configured to control the dose of water vapour to keep the reference feature within the selected time interval.

20. (canceled)

21. The apparatus of claim 17, wherein the drift chamber comprises an ion gate for controlling passage of ions from a reaction region into the drift chamber and one of:
(a) a detector separated from the ion gate by the drift chamber; and
(b) a passage to allow ions from the IMS cell to reach a spectrometer, such as a mass spectrometer.

22. The apparatus of claim 10 wherein the reservoir comprises a chamber, and one of: (a) a capsule of water disposed in the chamber, and (b) a water permeable barrier disposed between the chamber and an inlet for ambient air, wherein the barrier provides a pneumatic seal between the chamber and the inlet ambient air.

23. (canceled)

24. A method of operating ion mobility spectrometry (IMS) cell, the method comprising:
obtaining first IMS data indicating the time of flight of ions through a drift gas of the cell;
identifying, in the first IMS data, a reference feature associated with a selected group of ions;
providing a dose of water vapour into the drift gas;
obtaining second IMS data indicating the time of flight of ions through the drift gas comprising the dose of water vapour; and
indicating a maintenance status for the cell based on a difference in timing of the reference feature in the second IMS data compared to the reference feature in the first IMS data.

25. The method of claim 24 wherein indicating a maintenance status comprises indicating that a molecular sieve should be replaced in the event that the difference in timing is less than a selected threshold difference.

26. The method of claim 24 wherein the reference feature comprises a peak associated with at least one of: reactant ions, a calibrant, and a dopant.
